(19) United States
(12) Patent Application Publication
(10) Pub. No.: US 2007/0079266 A1
(43) Pub. Date: Apr. 5, 2007

(54) Method and computer program for analysis of an integrated circuit design to identify and resolve a problematic structure characterized by multiple rule violations using a design closure knowledge base and a physical design database

(75) Inventors: Krishna Devineni, Milpitas, CA (US); Juergen K. Lahner, Morgan Hill, CA (US); Gregory Pierce, Ashby, MA (US); Balamurugan Balasubramanian, Santa Clara, CA (US); Srinivas Adusumalli, San Jose, CA (US); Kiran Atmakuri, Sunnyvale, CA (US); Kavitha Chaturvedula, San Jose, CA (US); Randall P. Fry, Greenville, NC (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/241,033

(22) Filed: Sep. 30, 2005

(51) Int. Cl. G06F 17/50

(52) U.S. Cl. 716/5

(57) ABSTRACT

A method and computer program product analyzes an integrated circuit design to identify and resolve a problematic structure characterized by multiple rule violations uses a Design Closure Knowledge Base to generate a corrective action strategy in a Design Closure Guidance Report. In one embodiment, a method includes steps of receiving as input an integrated circuit design and a set of design rules, analyzing the integrated circuit design to identify design rule violations, and generating as output a compilation of each of the design rule violations and a corresponding list of primary and secondary objects in the integrated circuit design for each of the design rule violations. The compilation of each of the design rule violations and the corresponding list of primary and secondary objects in the integrated circuit design for each of the design rule violations is included in a Design Closure Knowledge Base to generate a detailed and structured strategy for resolving the design rule violations in the Design Closure Guidance Report.

### BACKGROUND OF THE INVENTION

1. Field of the Invention

The present invention is directed to application specific integrated circuit (ASIC) designs. More specifically, but without limitation thereto, the present invention is directed to identifying and correcting problems in RTL code for an integrated circuit design.

2. Description of the Prior Art

Previous approaches to correcting design defects in application specific integrated circuit (ASIC) designs require a significant amount of time analyzing the back-end flow, or layout, of the ASIC design. Attempting to resolve fundamental design problems at this late stage in the design typically increases turnaround time (TAT) and may jeopardize schedule commitments.

### SUMMARY OF THE INVENTION

A method and computer program product analyzes an integrated circuit design to identify and resolve a problematic structure characterized by multiple rule violations using a Design Closure Knowledge Base to generate a corrective action strategy in a Design Closure Guidance Report. In one embodiment, a method includes steps of:
(a) receiving as input an integrated circuit design and a set of design rules;
(b) analyzing the integrated circuit design to identify design rule violations; and
(c) generating as output a compilation of each of the design rule violations and a corresponding list of primary and secondary objects in the integrated circuit design for each of the design rule violations.

In another embodiment, the output is cross-referenced with architectural and structural attributes included in a Design Closure Knowledge Base to generate a detailed and structured strategy for resolving root causes of the design rule violations. The strategy for resolving the root causes of the design rule violations is included in the Design Closure Guidance Report.

In a further embodiment, a Physical Design Database is used in conjunction with the Design Closure Knowledge Base to generate the Design Closure Guidance Report when it becomes available during the design layout to provide more insight to the root causes and possible solutions for problems indicated by the design rule violations and actually encountered during physical design.

### BRIEF DESCRIPTION OF THE DRAWINGS

The above and other aspects, features and advantages will become more apparent from the description in conjunction with the following drawings presented by way of example and not limitation, wherein like references indicate similar elements throughout the several views of the drawings, and wherein:

FIG. 1 illustrates a functional block diagram 100 of a method of analyzing an integrated circuit design to identify and resolve a problematic structure characterized by multiple rule violations using a Design Closure Knowledge Base;

FIG. 2 illustrates a schematic diagram of a typical fanout logic cone in the integrated circuit design of FIG. 1;

FIG. 3 illustrates a schematic diagram of a typical fanin logic cone in the integrated circuit design of FIG. 1;

FIG. 4 illustrates a schematic diagram of a typical register array in the integrated circuit design of FIG. 1;

FIG. 5 illustrates a schematic diagram of a typical multiplexing structure in the integrated circuit design of FIG. 1;

FIG. 6 illustrates a schematic diagram of a typical register bottleneck structure in the integrated circuit design of FIG. 1;

FIG. 7 illustrates an example of a typical memory register array in the integrated circuit design of FIG. 1;

FIG. 8 illustrates a schematic diagram of a typical memory interface in the integrated circuit design of FIG. 1;

FIG. 9 illustrates a flow chart for a method of analyzing an integrated circuit design to identify and resolve a problematic structure characterized by multiple rule violations; and

FIG. 10 illustrates a flow chart for a computer program that summarizes the method of FIG. 9.

Elements in the figures are illustrated for simplicity and clarity and have not necessarily been drawn to scale. For example, the dimensions, sizing, and/or relative placement of some of the elements in the figures may be exaggerated relative to other elements to clarify distinctive features of the illustrated embodiments. Also, common but well-understood elements that may be useful or necessary in a commercially feasible embodiment are often not depicted in order to facilitate a less obstructed view of the illustrated embodiments.

### DESCRIPTION OF THE ILLUSTRATED EMBODIMENTS

The following description is not to be taken in a limiting sense, rather for the purpose of describing by specific examples the general principles that are incorporated into the illustrated embodiments. For example, certain actions or steps may be described or depicted in a specific order to be performed. However, practitioners of the art will understand that the specific order is only given by way of example and that the specific order does not exclude performing the described steps in another order to achieve substantially the same result. Also, the terms and expressions used in the description have the ordinary meanings accorded to such terms and expressions in the corresponding respective areas of inquiry and study except where other meanings have been specifically set forth herein.

Automated checking of RTL code for integrated circuits has previously been limited to detecting and removing extraneous information, or “lint”. Several investigations have determined that most ASIC design defects result from register transfer level (RTL) coding that does not take into account the physical design implementation. What may be efficient from a logical standpoint often leads to problems in the physical domain. Consequently, the RTL code may be logically correct and may be synthesized without a major problem; however, timing and routing congestion problems may arise during physical design that consume significant resources and schedule time to correct. In fact, many times the problems may not be resolved until the root cause design attributes are corrected or adjusted at the RTL level, sometimes even at the architectural level.

Examples of common RTL coding problems are excessive fanin and fanout logic cones, large multiplexing structures, especially multiplexing structures with overburdened select lines, structural or register bottlenecks, memory having control lines and data sinks and sources that are not local and dedicated specifically to that memory, centralized multiplexing of datapath and test structures, centralized control logic of complex finite state machine (FSM) or multiple finite state machine structures, and single-block configuration blocks such as status or configuration registers mapped across the die. These problems may best be resolved in the RTL code. As the design complexity of integrated circuits increases with limited engineering resources, design schedules become tighter. Consequently, it is desirable that the design analysis at the RTL or gate level be robust, efficient, and directed to ease of physical implementation. Techniques for analyzing RTL code by applying design rules one at a time are sufficient for a wide range of applications; however, in a growing number of increasingly complex integrated circuit designs, a more robust approach is needed to reduce complex cause-and-effect scenarios resulting from problematic architectures and structures to a meaningful and applicable prediction of the performance of an integrated circuit design. It is also desirable to provide the circuit designer with steps that may be taken to resolve failures of the predicted performance to meet design specifications during pre-layout and post-layout phases of the design cycle.

Previously, RTL or gate level analysis of an integrated circuit design has been performed by applying a set of design rules using electronic design analysis (EDA) tools. The design rules typically analyze the integrated circuit design independently of one another, focusing on a specific structural attribute for which each design rule is designed to detect and report a design rule violation. The task of iteratively reviewing all of the design rule reports generated by the design rules generally falls to a design engineer, who then manually determines what specific structures need to be addressed. Also, if the design engineer does not have broad and comprehensive experience with physical design implementation, the design engineer may not know what to look for or how to organize the report details that contain clues to the design problems. As a result, high-level architectural and structural problems are missed, because they are manifested across multiple rule violations of a single rule or across multiple rules that require a high degree of manual analysis effort, design analysis expertise, and time for identification. Disadvantageously, design corrections resulting from these multiple rule violations are frequently made that overlook the root cause of multiple design rule violations and only address individual manifestations of the underlying problem.

The problems described above may be overcome by accumulating the experience gained from previous integrated circuit designs in a Design Closure Knowledge Base to identify and resolve high level design problems as described below.

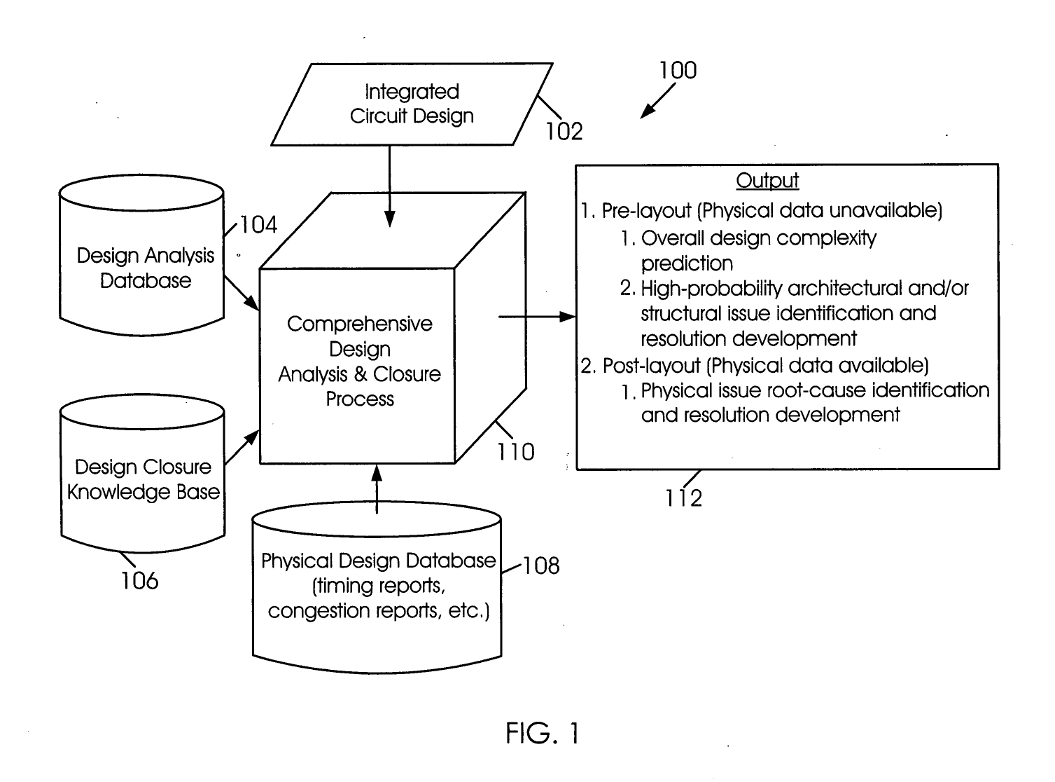

FIG. 1 illustrates a functional block diagram 100 of a method of analyzing an integrated circuit design to identify and resolve a problematic structure characterized by multiple rule violations using a Design Closure Knowledge Base. A Physical Design Database may be leveraged for the analysis when it becomes available during the design layout. Shown in FIG. 1 are an integrated circuit design 102, a Design Analysis Database 104, a Design Closure Knowledge Base 106, a Physical Design Database 108, a design analysis and closure block 110, and a Design Closure Guidance Report 112.

In FIG. 1, the integrated circuit design 102 includes information that defines at least a portion of an integrated circuit design. For example, the information may be in the form of register transfer level (RTL) code in Verilog format or Verilog Hardware Description Language (VHDL) format, a netlist, and the Physical Design Database 108 that includes timing and routing congestion analysis information from the layout of the integrated circuit design. The RTL information may be used to perform the design analysis early in the design cycle, before committing resources to logic gates. In another embodiment, the netlist information may be used to perform the design analysis at an intermediate stage in the design cycle before committing resources to a specific technology. In a further embodiment, the Physical Design Database 108 may be used to analyze the integrated circuit design in a later stage of the design cycle when the results of a static timing and routing congestion analysis become available. In one embodiment, the integrated circuit design 102 includes information that defines a selected portion of an integrated circuit design. In another embodiment, the integrated circuit design 102 includes information that defines the entire integrated circuit design.

The design analysis database 104 includes a consistent and coherent organization of the primary and secondary objects in the integrated circuit design that are associated with design rule violations. A primary object is defined herein as a module, a hierarchical block a cell, net, pin, port, or other physical feature in the integrated circuit design that is directly connected to an architectural or structural attribute. An architectural attribute is an intended design function of the integrated circuit, for example, an embedded memory interfaced directly with chip input/output (I/O) or an embedded memory implemented as a register array. A structural attribute is a structure that is generated as a result of RTL coding, synthesis, or other design tool to implement the design function. Examples of structural attributes are large multiplexers, large logic cones, and high fanout nets; each of which may result in a routing density that violates one or more design rules. The design analysis database 104 includes a consistent and coherent organization of the reports generated by the design rules.

The Design Closure Knowledge Base 106 is a historical collection of architectural and structural attributes that have resulted in design closure problems in previous integrated circuit designs, such as certain floorplans, die utilization, memory locations, fixed coreware/IP locations, cell locations, I/O locations, blockages, random logic gate count percentages, and so on. The Design Closure Knowledge Base 106 also includes strategies used to resolve the design closure problems for each of the problematic architectural and structural attributes.

The Physical Design Database 108 includes information and reports from the physical design environment, such as the results of a static timing and routing congestion analysis performed on a layout of the integrated circuit design. Depending on the stage in the design cycle in which the method of FIG. 1 is applied, the Physical Design Database 108 may not be available.

The design analysis and closure block 110 performs an analysis of the integrated circuit design 102 to generate the Design Analysis Database 104. For example, the RTL code may be checked for design rule violations as described by Lahner et al. in U.S. patent application Ser. No. 10/427,609, filed on Apr. 30, 2003 and incorporated herein by reference. The netlist may be checked for timing design rule violations, for example, as described by Fry, et al. in U.S. patent application Ser. No. 10/984,115, filed on Nov. 8, 2004 and incorporated herein by reference. Other commercially available design tools may be used to analyze a netlist of the integrated circuit design according to well-known techniques to generate the Design Analysis Database 104 and the Physical Design Database 108. After generating the Design Analysis Database 104, the design analysis and closure block 110 searches the Design Analysis Database 104 for multiple rule violations within a given rule or across multiple rules listed for the same primary or secondary object associated with one of the architectural and structural attributes. An example of a primary object would be a register that drives a large fanout cone, while an example of a secondary object would be a register that drives the data input of the fanout logic cone source register. The design analysis and closure block 110 compares the architectural and structural attributes associated with each of the primary and secondary objects to the architectural and structural attributes known to have resulted in design closure problems in the Design Closure Knowledge Base 106. For each comparison match, the corresponding solutions and alternatives to the problematic architectural and structural attributes are included in the Design Closure and Guidance Report 112.

The following are examples of structural attributes that may result in design closure problems.

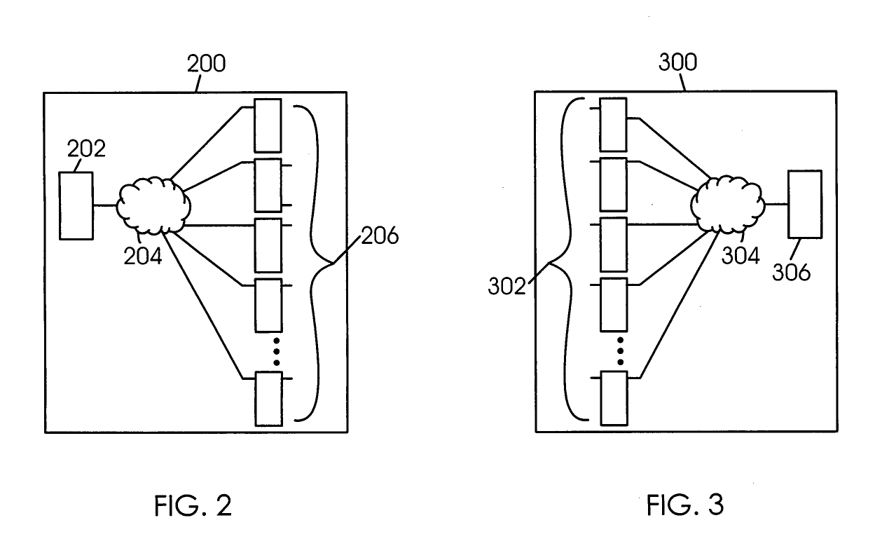

FIG. 2 illustrates a schematic diagram of a typical fanout logic cone 200 in the integrated circuit design 102 of FIG. 1. Shown in FIG. 2 are a driving register 202, a logic cloud 204, and output registers 206.

In FIG. 2, a large number of connections from the logic cloud 204 to the output registers 206 may result in a high routing density that could trigger a design rule violation.

FIG. 3 illustrates a schematic diagram of a typical fanin logic cone 300 in the integrated circuit design 102 of FIG. 1. Shown in FIG. 3 are driving registers 302, a logic cloud 304, and an input register 306.

In FIG. 3, a large number of connections from the driving registers 302 to the input register 306 may result in a high routing density that could trigger a design rule violation.

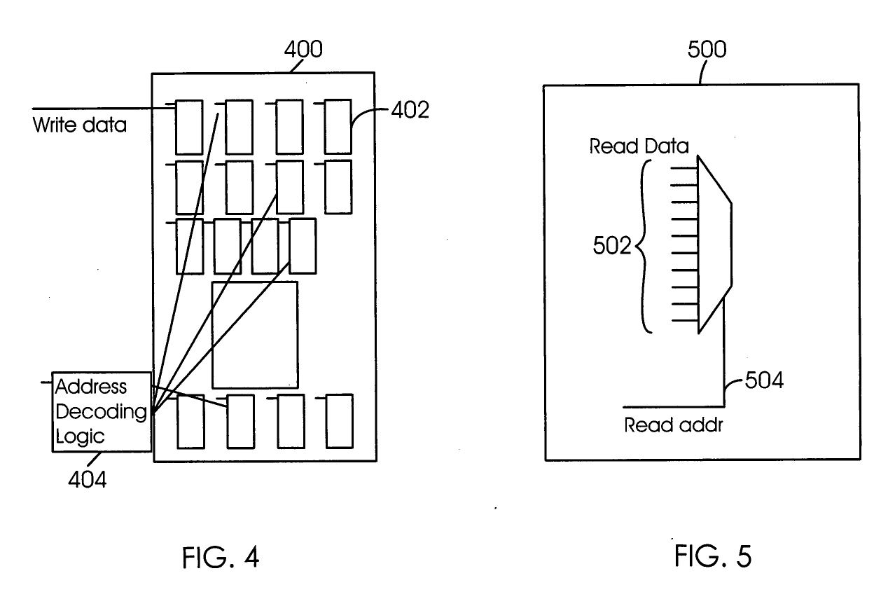

FIG. 4 illustrates a schematic diagram of a typical register array 400 in the integrated circuit design 102 of FIG. 1. Shown in FIG. 4 are a registers 402 and address decoding logic 404.

In FIG. 4, a large number of connections from the address decoding logic 404 to the registers 402 may result in a high routing density that could trigger a design rule violation.

FIG. 5 illustrates a schematic diagram of a typical multiplexing structure 500 in the integrated circuit design 102 of FIG. 1. Shown in FIG. 5 are a input read lines 502 and a read address line 504.

Multiple multiplexing structures 500 may share the same select signal source used to drive the read address line 504, or they may share a common data source or a common data destination, which frequently results in timing and routing congestion problems during placement and routing, but may be avoided by modifications to the RTL code.

The following are some examples of architectural and structural attributes typically found in an integrated circuit design that have resulted in design closure problems in previous integrated circuit designs.

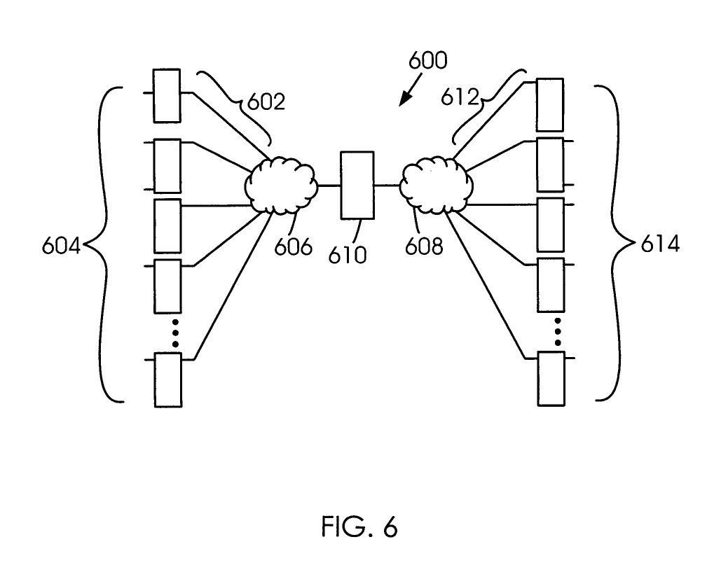

FIG. 6 illustrates a schematic diagram of a typical register bottleneck structure 600 in the integrated circuit design 102 of FIG. 1. Shown in FIG. 6 are a logic fanin cone 602, input registers 604, logic clouds 606 and 608, a bottleneck register 610, a logic fanout cone 612, and output registers 614.

In FIG. 6, the bottleneck register 610 is both a sink for the logic fanin cone 602 and a source for the logic fanout cone 612. Accordingly, the bottleneck register 610 is a primary object associated with the register bottleneck structure 602. If the routing density of both the logic fanin cone 602 and the logic fanout cone 612 exceeds the design rule limits, then the bottleneck register 610 would be a repeated instance of a primary object in two design rule violations. Because the input registers 604 are connected to the logic fanin cone 602 and the output registers 614 are connected to the logic fanout cone 612, the input registers 604 and the output registers 614 are secondary objects associated with the bottleneck structure 600.

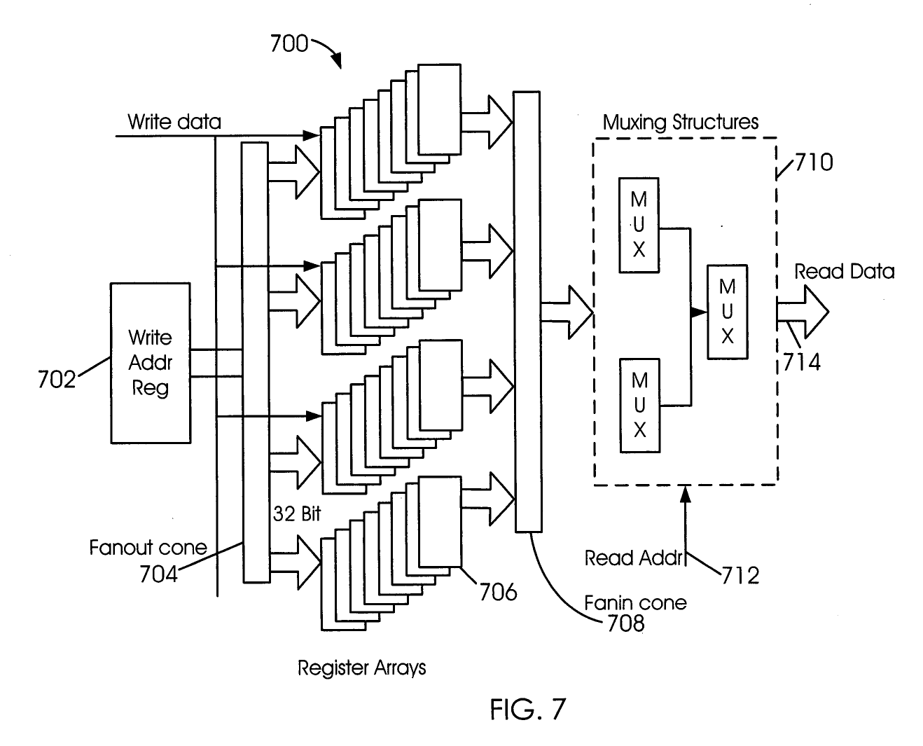

FIG. 7 illustrates an example of a typical memory register array 700 in the integrated circuit design 102 of FIG. 1. Shown in FIG. 7 are a write address register 702, a logic fanout cone 704, registers 706, a logic fanin cone 708, multiplexing structures 710, a read address line 712, and read data lines 714.

In FIG. 7, a large number of the registers 706 used as a memory results in the large multiplexing structures 710 on the read data lines 714, the large logic fanin cone 708, the large logic fanout cone 704, and so on. By identifying the memory register array 700 as the problematic architectural attribute that results in multiple design violations, the circuit designer may be guided rapidly to a solution that substitutes a true memory in place of the register array, correcting most of the design rule violations generated by the same problem at the same time. Without identifying the memory register array 700 as the problematic architectural attribute that results in multiple design rule violations, the circuit designer may be led to attempt solutions to the various manifestations of the problem by correcting one design rule violation at a time. Disadvantageously, correcting one design rule violation at a time may consume more valuable schedule time and may not succeed in correcting all of the design rule violations.

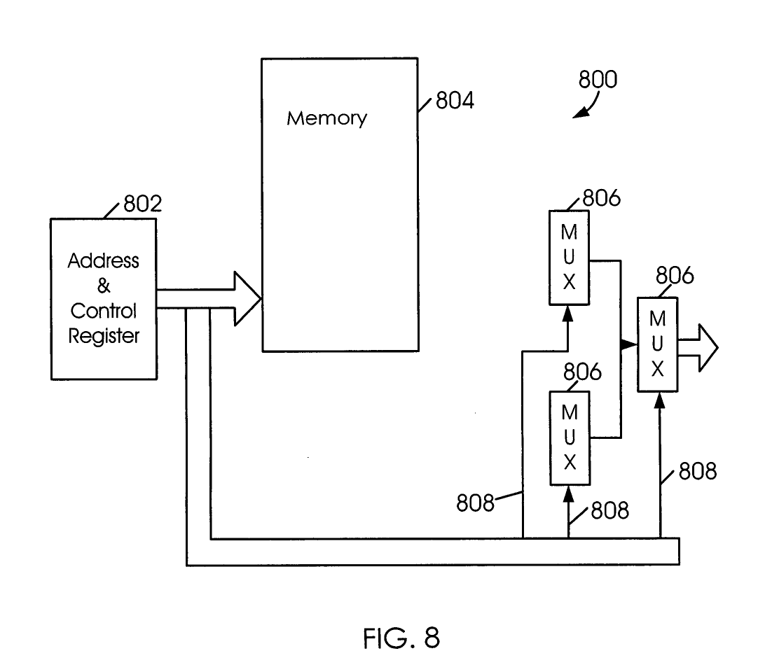

FIG. 8 illustrates a schematic diagram of a typical memory interface 800 in the integrated circuit design 102 of FIG. 1. Shown in FIG. 8 are an address and control register 802, a memory 804, multiplexing structures 806, and select lines 808.

In FIG. 8, the address and control register 802 is used not only for controlling the memory 804, but also for selecting the datapath multiplexing structures 806. As a result, the address and control register 802 is part of a fanout logic cone that may be problematic in itself. In addition, the placement tool will attempt to locate the address and control register 802 near the memory 804 and near the multiplexing structures 806, resulting in a tug-of-war conflict that may prevent achieving timing closure for the address and control register 802.

The Design Closure and Guidance Report 112 generated by the design analysis and closure block 110 in FIG. 1 may be used to practice various embodiments within the scope of the appended claims. For example, in one embodiment, the number of multiple rule violations for the same architectural or structural attribute may by used as a measure of the complexity of implementing the integrated circuit design in terms of die size, routing congestion, timing slack, testability, and so on. The measure of complexity may be valuable information for a design team to consider in evaluating the feasibility of the circuit design as well as the resources in terms of cost and manpower required to implement the integrated circuit design.

In another embodiment, the Design Closure and Guidance Report 112 may be used to construct a detailed and comprehensive strategy to resolve design rule violations that will most probably result in physical implementation problems such as negative timing slack, routing congestion conflicts, and so on. For example, the problematic memory interface 800 may be modified to include a duplicate of the address and control register 802, providing a separate address and control register for each of the memory 804 and the multiplexing structures 806. The placement tool will then locate one address and control register near the memory 804 and the other address and control register near the multiplexing structures 806 to resolve possible timing problems, avoiding the conflict resulting from attempting to place the single address and control register 802.

In a further embodiment, the Design Closure and Guidance Report 112 may be used to correlate actual routing congestion and timing failures with problematic structures in the integrated circuit design by cross-referencing the cell names appearing in a problem area of the integrated circuit design with the cell names of the structures listed in the design analysis database 104. When the cause of a routing congestion or timing problem is identified with a structure and/or a higher-level architectural attribute by the design analysis and closure block 110, a layered strategy for resolving the problem may be developed from the Design Closure Knowledge Base 106. For example, the design rule violations may be addressed in a preferred order, such as I/O timing first, then memory interfacing, then coreware interfacing, then high-speed logic, and so on.

A method and computer program product analyzes an integrated circuit design to identify and resolve a problematic structure characterized by multiple rule violations using a Design Closure Knowledge Base to generate a corrective action strategy in a Design Closure Guidance Report. In one embodiment, a method includes steps of:
(a) receiving as input an integrated circuit design and a set of design rules;
(b) analyzing the integrated circuit design to identify design rule violations; and
(c) generating as output a compilation of each of the design rule violations and a corresponding list of primary and secondary objects in the integrated circuit design for each of the design rule violations.

In another embodiment, the output is cross-referenced with architectural and structural attributes included in a Design Closure Knowledge Base to generate a detailed and structured strategy for resolving root causes of the design rule violations. The strategy for resolving the root causes of the design rule violations is included in the Design Closure Guidance Report.

In a further embodiment, a Physical Design Database is used in conjunction with the Design Closure Knowledge Base to generate the Design Closure Guidance Report when it becomes available during the design layout to provide more insight to the root causes and possible solutions for problems indicated by the design rule violations and actually encountered during physical design.

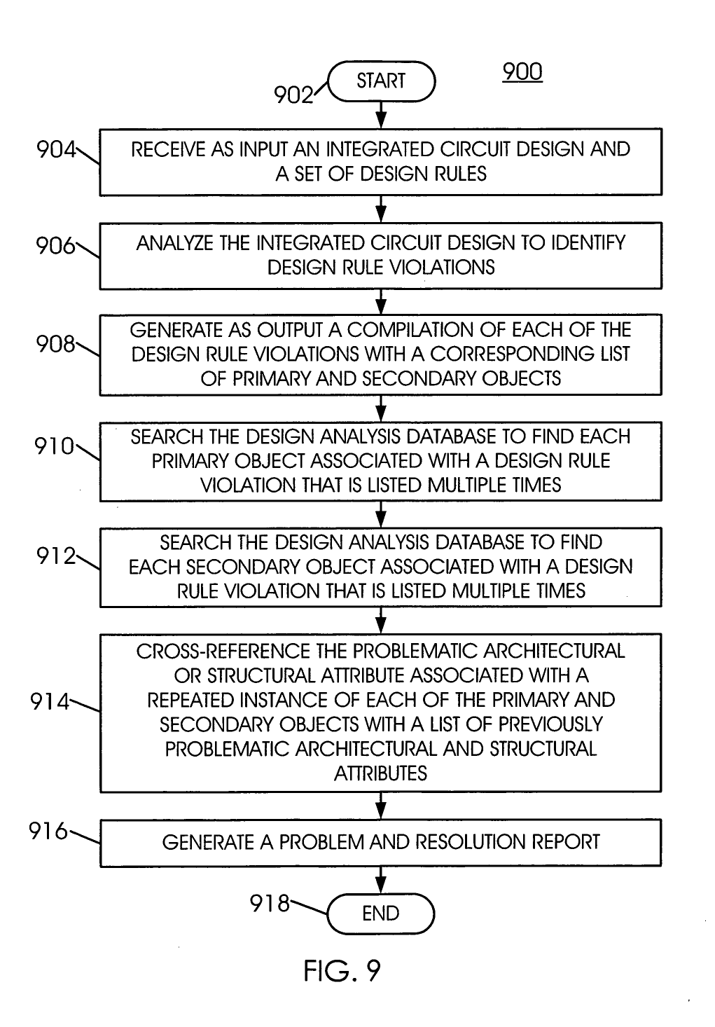

FIG. 9 illustrates a flow chart 900 for a method of analyzing an integrated circuit design to identify and resolve a problematic structure characterized by multiple rule violations.

Step 902 is the entry point for the flow chart 900.

In step 904, an integrated circuit design and a set of design rules are received as input. The integrated circuit design may be in the form of, for example, RTL code or a netlist. The design rules may be generated by various design tools according to well-known techniques.

In step 906, the integrated circuit design is analyzed to identify design rule violations according to well-known techniques. Depending on how late in the design cycle the design analysis is performed, a Physical Design Database may be available that includes timing and routing congestion information from the placement and routing of the integrated circuit design.

In step 908, a compilation of each of the design rule violations is generated as output with a corresponding list of primary and secondary objects. For example, an entry for each design rule violation is created in a Design Analysis Database that includes the primary and secondary objects that resulted in the design rule violation. That is, each entry in the Design Analysis Database includes the design rule violation, the primary objects that triggered the design rule violation, and the secondary objects that are connected to the primary objects. The secondary objects are included in the design analysis database for each design rule violation as well as the primary objects to detect more problematic architectural and structural attributes than would be possible from considering only the primary objects.

In step 910, the Design Analysis Database is searched to find each primary object associated with a design rule violation that is listed multiple times to detect instances in which the same primary object is associated with more than one design rule violation. The results of the search are added to the Design Analysis Database.

In step 912, the Design Analysis Database is searched to find each secondary object associated with a design rule violation that is listed multiple times to detect instances in which the same secondary object is associated with more than one design rule violation. The results of the search are added to the Design Analysis Database.

In step 914, the problematic architectural or structural attribute associated with a repeated instance of each of the primary and secondary objects in the Design Analysis Database is cross-referenced with a list of architectural and structural attributes known to have resulted in a design closure problem in a previous integrated circuit design. The list of previously problematic architectural and structural attributes may be compiled empirically and accumulated, for example, in a Design Closure Knowledge Base along with the corresponding solutions from the previous integrated circuit designs that were used to resolve each problem. An exemplary list of problematic architectural and structural attributes includes the following:
(1) memory interface: memory inputs connected to fanin logic cones, memory outputs connected to fanout logic cones, address/control registers that are shared with other structures, register sources for memory inputs that are also sources for fanout logic cones, and register sinks for memory outputs that are also sources for fanout logic cones;
(2) register bottleneck: a register that is both a sink for a large fanin logic cone and the source for a large fanout logic cone;
(3) fanin/fanout logic cone intersection: an endpoint register for a fanout logic cone that is also an endpoint register for a fanin logic cone or the startpoint for a fanin logic cone that is also the startpoint for a fanout logic cone;
(4) shared multiplexer select: the same multiplexer select source signal is shared among multiple multiplexing structures;
(5) multiplexing structure in logic cone: a fanin or fanout logic cone associated with a multiplexing structure;
(6) multiplexing source analyzer: the data source for a multiplexing structure is a primary input, a memory output, an embedded coreware/IP output, a register array output, or a latch-based random access memory (RAM) output;
(7) common startpoint for multiple fanin logic cones: multiple fanin logic cones have the same startpoint register;
(8) common startpoint for multiple fanout logic cones: multiple fanout logic cones have the same endpoint register; and
(9) module/hierarchy specific: structural and architectural attributes in a specific module or hierarchy level of an integrated circuit design that are known to be problematic.

In step 916, a Design Closure Guidance Report is generated from the results of cross-referencing the design analysis database with previously problematic architectural and structural attributes in the Design Closure Knowledge Base. A pre-layout report problem prediction and resolution is generated if the placement and routing has not yet been performed, for example, to detect design problems in the RTL code. A post-layout problem resolution report is generated after the placement and routing has been performed, that is, when the Physical Design Database becomes available that includes the information generated by a static timing and routing congestion analysis of the integrated circuit design.

In various embodiments of the pre-layout report, the Design Closure Guidance Report includes an overall design complexity prediction based on whether the type, number, and magnitude of design problems will manifest themselves as timing failures, routing congestion, testability, or manufacturability problems. The Design Closure Guidance Report also identifies architectural and/or structural attributes in the integrated circuit design that have a high probability of becoming problematic during the physical design of the integrated circuit. Further, the Design Closure Guidance Report offers solutions to the design problems identified in the integrated circuit design that were used successfully to resolve the same problems in previous integrated circuit designs.

In various embodiments of the post-layout report, the architectural and/or structural attributes in the integrated circuit design are identified that are manifested in the problems reported in the Physical Design Database. Specifically, the cells named in the problem areas of the integrated circuit design are cross-referenced to the cells in the architectural and structural attributes known to have been problematic in previous integrated circuit designs. Further, the Design Closure Guidance Report offers structurally detailed solutions to the design problems identified in the integrated circuit design that were used successfully to resolve the same problems in the previous integrated circuit designs.

Step 918 is the exit point for the flow chart 900.

The flow chart described above with reference to FIG. 9 may also be automated by instructions for a computer. The instructions may be embodied in a disk, a CD-ROM, and other computer readable media according to well known computer programming techniques.

A computer program product that analyzes an integrated circuit design to identify and resolve a problematic structure characterized by multiple rule violations uses a Design Closure Knowledge Base to generate a corrective action strategy in a Design Closure Guidance Report. In one embodiment, a computer program product includes:
a medium for embodying a computer program for input to a computer; and a computer program embodied in the medium for causing the computer to perform steps of:
(a) receiving as input an integrated circuit design and a set of design rules;
(b) analyzing the integrated circuit design to identify design rule violations; and
(c) generating as output a compilation of each of the design rule violations and a corresponding list of primary and secondary objects in the integrated circuit design for each of the design rule violations.

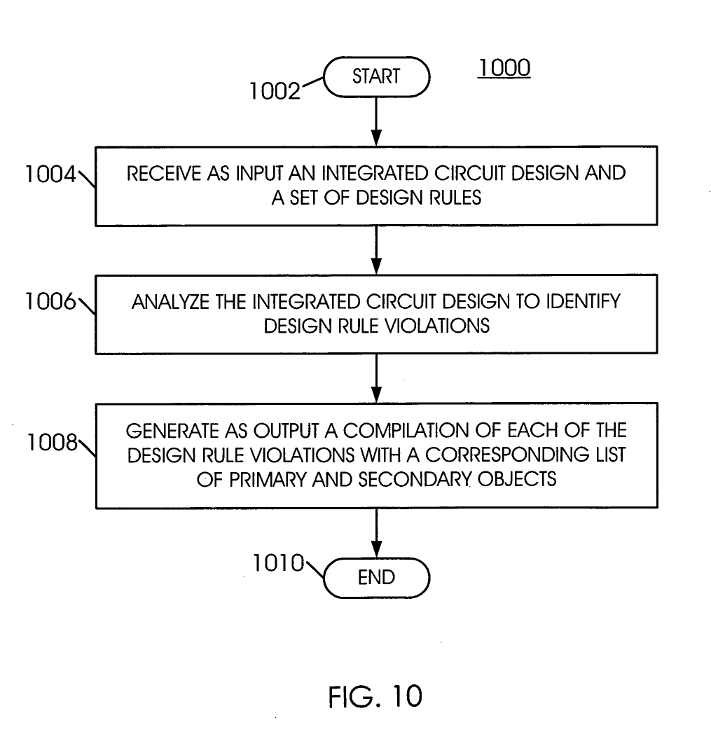

FIG. 10 illustrates a flow chart 1000 for a computer program that summarizes the method of FIG. 9.

Step 1002 is the entry point for the flow chart 1000.

In step 1004, an integrated circuit design and a set of design rules are received as input.

In step 1006, the integrated circuit design is analyzed to identify design rule violations as described above.

In step 1008, a compilation of each of the design rule violations and a corresponding list of primary and secondary objects in the integrated circuit design for each of the design rule violations is generated as output, for example, in a Design Analysis Database.

Step 1010 is the exit point for the flow chart 1000.

Although the flowchart descriptions above are described and shown with reference to specific steps performed in a specific order, these steps may be combined, sub-divided, or reordered without departing from the scope of the claims. Unless specifically indicated, the order and grouping of steps is not a limitation of other embodiments that may lie within the scope of the claims.

The specific embodiments and applications thereof described above are for illustrative purposes only and do not preclude modifications and variations that may be made within the scope of the following claims.

What is claimed is:

1. A method comprising steps of:
(a) receiving as input an integrated circuit design and a set of design rules;
(b) analyzing the integrated circuit design to identify design rule violations; and
(c) compiling each of the design rule violations and a corresponding list of primary and secondary objects in the integrated circuit design for each of the design rule violations.

2. The method of claim 1 further comprising a step (d) of comparing the primary and secondary objects in the integrated circuit design with a Design Closure Knowledge Base to generate a Design Closure Guidance Report that includes a detailed and structured strategy for resolving the design rule violations.

3. The method of claim 2 wherein step (d) comprises searching each list of primary and secondary objects for a repeated instance of one of the primary objects.

4. The method of claim 3 further comprising a step of comparing a problematic architectural or structural attribute associated with the repeated instance of the primary object with a list of architectural and structural attributes known to have resulted in a design closure problem in a previous integrated circuit design.

5. The method of claim 4 wherein the problematic architectural or structural attribute includes one of a fanout logic cone, a fanin logic cone, a register array, a multiplexing structure, a register bottleneck, a register array, a memory interface, and a multiplexing structure.

6. The method of claim 5 further comprising a step of generating as output the problematic architectural or structural attribute associated with the repeated instance of one of the primary objects for which a match is found in the list of architectural and structural attributes and a solution to the design closure problem from the previous integrated circuit design.

7. The method of claim 6 further comprising a step of searching each list of primary and secondary objects for a repeated instance in the integrated circuit design of one of the secondary objects.

8. The method of claim 7 further comprising a step of comparing a problematic architectural or structural attribute associated with the repeated instance of the secondary object with a list of architectural and structural attributes known to have resulted in a design closure problem in a previous integrated circuit design.

9. The method of claim 8 wherein the problematic architectural or structural attribute is one of a fanout logic cone, a fanin logic cone, a register array, a multiplexing structure, a register bottleneck, a register array, a memory interface, and a multiplexing structure.

10. The method of claim 9 further comprising a step of generating as output the problematic architectural or structural attribute associated with the repeated instance of one of the secondary objects for which a match is found in the list of architectural and structural attributes and a solution to the design closure problem from the previous integrated circuit design.

11. The method of claim 1 wherein step (b) includes one of analyzing RTL code, analyzing a netlist, and performing a static timing and routing congestion analysis.

12. The method of claim 1 further comprising a step of compiling a Design Closure Knowledge Base including a list of architectural and structural attributes and a corresponding solution to design closure problems from previous integrated circuit designs for each of the architectural and structural attributes.

13. The method of claim 1 further comprising a step of generating a post-layout report that identifies the architectural and/or structural attributes in the integrated circuit design that are manifested in problems reported in a Physical Design Database.

14. A computer program product comprising:
a medium for embodying a computer program for input to a computer; and
a computer program embodied in the medium for causing the computer to perform steps of:
(a) receiving as input an integrated circuit design and a set of design rules;
(b) analyzing the integrated circuit design to identify design rule violations; and
(c) compiling each of the design rule violations and a corresponding list of primary and secondary objects in the integrated circuit design for each of the design rule violations.

15. The computer program product of claim 14 further comprising a step (d) of comparing the primary and secondary objects with a Design Closure Knowledge Base to generate a Design Closure Guidance Report that includes a detailed and structured strategy for resolving the design rule violations.

16. The computer program product of claim 15 wherein step (d) comprises searching each list of primary and secondary objects for a repeated instance of one of the primary objects.

17. The computer program product of claim 16 further comprising a step of comparing a problematic architectural or structural attribute associated with the repeated instance of one of the primary objects with a list of architectural and structural attributes known to have resulted in a design closure problem in a previous integrated circuit design.

18. The computer program product of claim 17 wherein the problematic architectural or structural attribute is one of a fanout logic cone, a fanin logic cone, a register array, a multiplexing structure, a register bottleneck, a register array, and a memory interface.

19. The computer program product of claim 18 further comprising a step of generating as output the problematic architectural or structural attribute associated with the repeated instance of one of the primary objects for which a match is found in the list of architectural and structural attributes and a solution to the design closure problem found for the previous integrated circuit design.

20. The computer program product of claim 14 further comprising a step of searching each list of primary and secondary objects for a repeated instance in the integrated circuit design of one of the secondary objects.

21. The computer program product of claim 20 further comprising a step of comparing a problematic architectural or structural attribute associated with the repeated instance of one of the secondary objects with a list of architectural and structural attributes known to have resulted in a design closure problem in a previous integrated circuit design.

22. The computer program product of claim 21 wherein the problematic architectural or structural attribute is one of a fanout logic cone, a fanin logic cone, a register array, a multiplexing structure, a register bottleneck, a register array, and a memory interface.

23. The computer program product of claim 22 further comprising a step of generating as output the problematic architectural or structural attribute associated with the repeated instance of one of the secondary objects for which a match is found in the list of architectural and structural attributes and a solution to the design closure problem from the previous integrated circuit design.

24. The computer program product of claim 14 wherein step (b) includes one of analyzing RTL code, analyzing a netlist, and performing a static timing and routing congestion analysis.

25. The computer program product of claim 14 further comprising a step of compiling a Design Closure Knowledge Base including a list of architectural and structural attributes and a corresponding solution to design closure problems from previous integrated circuit designs for each of the architectural and structural attributes.

26. The computer program product of claim 14 further comprising a step of generating a post-layout report that identifies the architectural and/or structural attributes in the integrated circuit design that are manifested in problems reported in a Physical Design Database.
